(19) United States
(12) Patent Application Publication
(10) Pub. No.: US 2011/0138660 A1
(43) Pub. Date: Jun. 16, 2011

(54) Snow Removal and Silage Moving Attachment Device and Method of Use

(76) Inventor: Chad Wyman Van Laecken, Mitchell, SD (US)

(21) Appl. No.: 12/948,438

(22) Filed: Nov. 17, 2010

Related U.S. Application Data
(60) Provisional application No. 61/262,032, filed on Nov. 17, 2009.

(51) Int. Cl. E01H 5/06; A01B 35/02; A01B 79/00

(52) U.S. Cl. 37/197; 37/231; 172/273; 172/1

(57) ABSTRACT

The present invention is a snow removal attachment device used in combination with a piece of snow removal equipment that includes a rubberized pushing tool that is disposed in front of the snow removal attachment device that pushes and moves snow while being used in combination with the snow removal equipment and a mounting and support bracket that removably mounts and secures the rubberized pushing tool to the snow removal equipment. There is also a quick release plate that attaches the mounting and support bracket to the snow removal equipment and a stabilizing chain that stabilizes said rubberized pushing tool and said mounting and support bracket. The invention can also be used to move silage and also includes a method of use.

This application claims priority to U.S. Provisional Application 61/262,032 filed on Nov. 17, 2009, the entire disclosure of which is incorporated by reference.

### TECHNICAL FIELD & BACKGROUND

The present invention generally relates to a snow removal and silage moving attachment device and method of use. More specifically, the invention is a snow removal and silage moving attachment device and method of use that can be used in combination with a variety of different types of snow removal or silage moving equipment.

It is an object of the invention to provide a snow removal and silage moving attachment device that can gather and push more snow or silage than a conventional snow removal and silage moving attachment device. It is an object of the invention to provide a snow removal and silage moving attachment device that has a pushing tool made of rubberized material where snow or silage cannot build-up and clog the snow removal and silage moving attachment device.

It is an object of the invention to provide a snow removal and silage moving attachment device that can absorb the impact and jarring effect from hitting hard objects and curbs while removing snow or moving silage.

It is an object of the invention to provide a snow removal and silage moving attachment device that reduces or eliminates surface wear and tear on road or other ground surfaces.

What is really needed is a snow removal and silage moving attachment device and method of use that can gather and push more snow and silage than a conventional snow removal and silage moving attachment device, that has a pushing tool made of rubberized material where snow or silage cannot build-up and clog the snow removal and silage moving attachment device, that can absorb the impact and jarring effect from hitting hard objects and curbs while removing snow or silage and that reduces or eliminates surface wear and tear on road and ground surfaces.

### BRIEF DESCRIPTION OF THE DRAWINGS

The present invention will be described by way of exemplary embodiments, but not limitations, illustrated in the accompanying drawings in which like references denote similar elements, and in which:

FIG. 1A illustrates a front view of a snow removal and silage moving attachment device, in accordance with one embodiment of the present invention.

FIG. 1B illustrates a front perspective view of a snow removal and silage moving attachment device, in accordance with one embodiment of the present invention.

FIG. 2A illustrates a rear perspective view of a snow removal and silage moving attachment device, in accordance with one embodiment of the present invention.

FIG. 2B illustrates a diagonal side perspective view of a snow removal and silage moving attachment device, in accordance with one embodiment of the present invention.

FIG. 3 illustrates a flow chart of a method for using a snow removal and silage moving attachment device, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

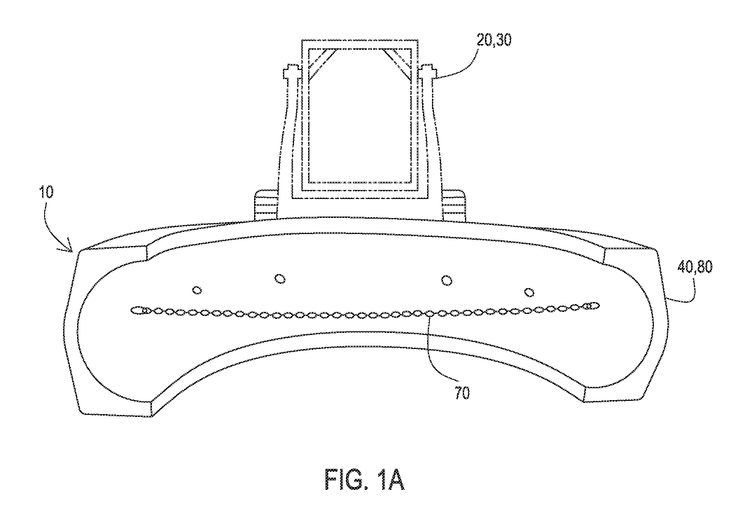

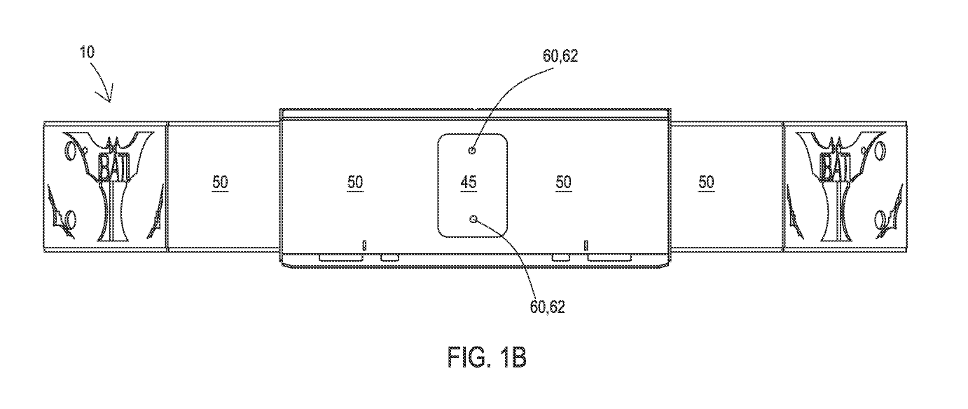

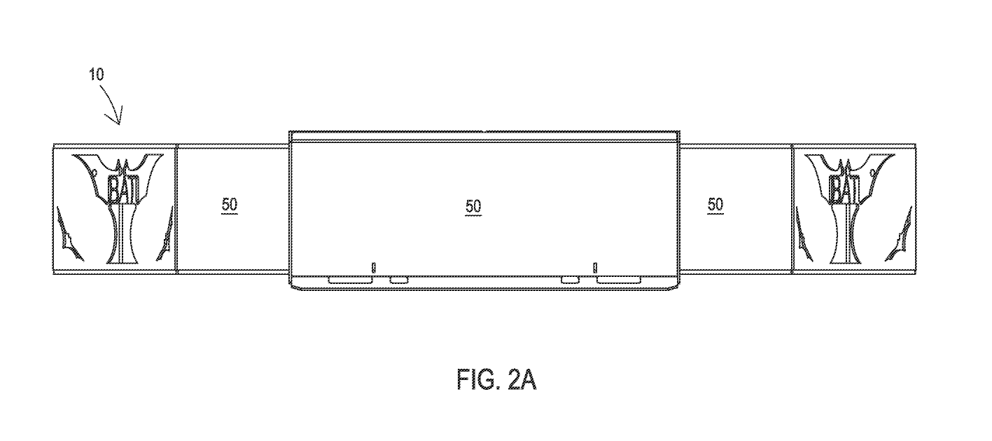

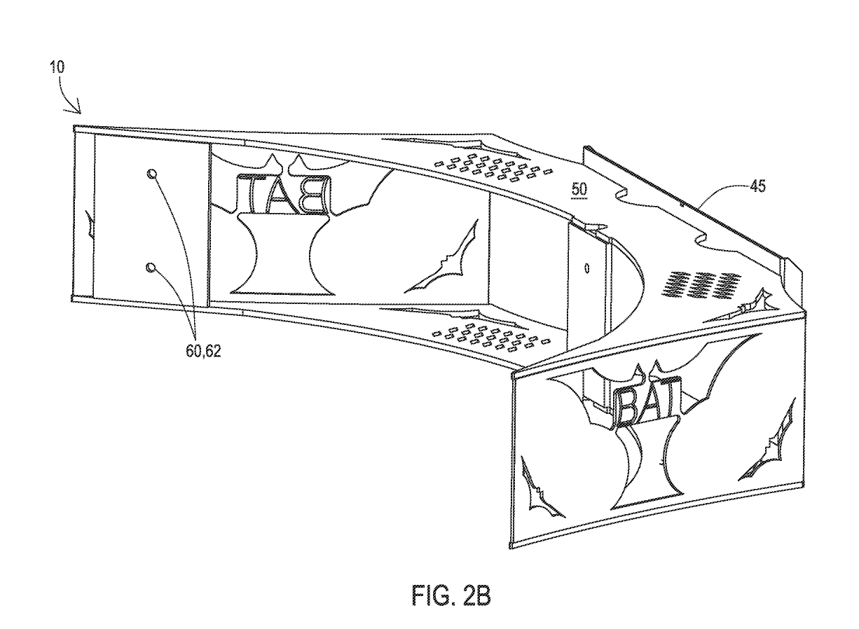

FIG. 1A illustrates an environmental front perspective view of a snow removal and silage moving attachment device 10, in accordance with one embodiment of the present invention. FIG. 1B illustrates a front view of a quick release mounting and support bracket 50 with a quick release plate 45 for a snow removal and silage moving attachment device 10, in accordance with one embodiment of the present invention. FIG. 2A illustrates a rear perspective view of a snow removal and silage moving attachment device 10, in accordance with one embodiment of the present invention. FIG. 2B illustrates a side perspective view of a snow removal and silage moving attachment device 10, in accordance with one embodiment of the present invention. The snow removal and silage attachment device 10 can be used in combination with a piece of snow removal equipment 20 or used in combination with a piece of silage moving equipment 30 to remove snow or move silage.

The snow removal and silage moving attachment device 10 includes a rubberized pushing tool 40 that is disposed in front of the snow removal and silage moving attachment device 10 that pushes and moves snow while being used in combination with the snow removal equipment 20. There is also a mounting and support bracket 50 that removably mounts and secures the rubberized pushing tool 40 to the snow removal equipment 20 and a quick release plate 45 that attaches the mounting and support bracket 50 to the snow removal equipment 20. The plurality of fasteners 60 that are used are mounting bolts 62, although other fasteners that are well known in the art can be used. There is also a stabilizing chain 70 that stabilizes the rubberized pushing tool 40 and the quick release mounting and support bracket 50. The rubberized pushing tool 40 is made of a recycled tire section 80, which is semi-circular shaped, although other shapes of recycled tire sections that are well known in the art can also be used. The snow removal equipment typically used in combination with the snow removal and silage moving attachment device 10 is a skid loader (not shown), although other pieces of snow removing equipment that are well known in the art can also be used.

The snow removal and silage moving attachment device 10 can also be used in combination with a piece of silage moving equipment 30, with the rubberized pushing tool 40 disposed in front of the snow removal and silage moving attachment device 10 that moves silage while being used in combination with the silage moving equipment 30. There is also a mounting and support bracket 50 that removably mounts and secures the pushing tool 40 to the silage moving equipment 30, a quick release plate 45 attaches the mounting and support bracket 50 to the silage moving equipment 30 and a stabilizing chain 70 that stabilizes the rubberized pushing tool 40 and the mounting and support bracket 50. The plurality of fasteners 60 that are used are mounting bolts 62, although other fasteners that are well known in the art can be used. The rubberized pushing tool 40 is made from a recycled tire section 80, which is semi-circular shaped, although other shapes of recycled tire sections that are well known in the art can also be used. The silage moving equipment 40 typically used in combination with the snow removal and silage moving attachment device 10 is a tractor or a fork lift (not shown), although other pieces of silage moving equipment 30 that are well known in the art can also be used.

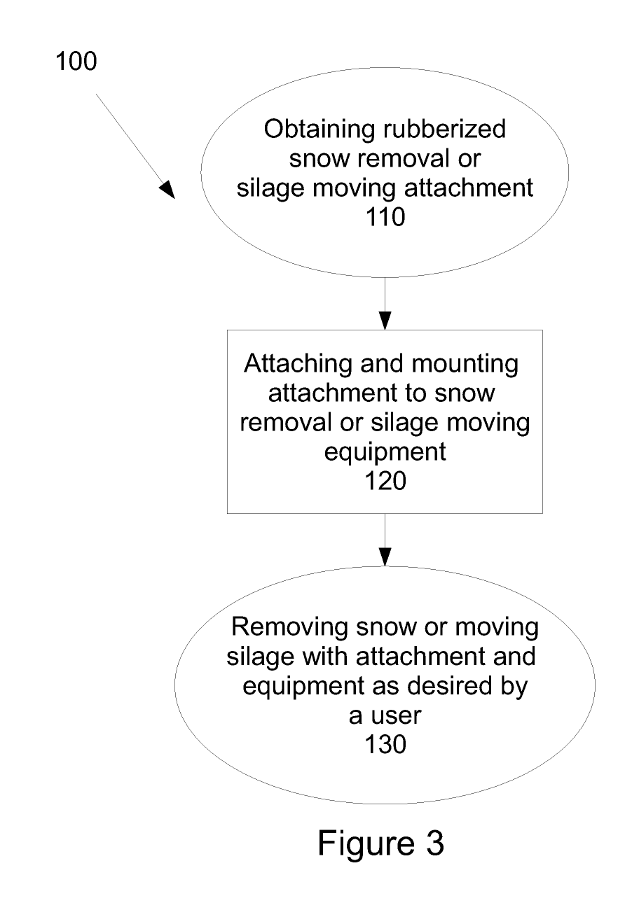

FIG. 3 illustrates a flow chart of a method for using a snow removal and silage moving attachment device 100, in accordance with one embodiment of the present invention. A method for using a rubberized snow removal and silage moving attachment device or rubberized silage moving attachment used in combination with a piece of snow removal equipment or silage moving equipment 100 includes the steps of obtaining the rubberized snow removal or rubberized silage moving attachment 110, attaching and mounting the rubberized snow removal or rubberized silage moving attachment to the snow removal equipment or the silage moving equipment 120 and removing snow or moving silage with the rubberized snow removal or rubberized silage moving attachment and the snow removal equipment or the silage moving equipment as desired by a user 130.

Like the previously described snow removal and silage moving attachment device 10, the rubberized snow removal and silage moving attachment device or rubberized silage moving attachment device used in the method 100 utilizes a pushing tool that is made of a recycled tire section that is semi-circular shaped, although other shapes of recycled tire sections that are well known in the art can also be used. The method 100 uses a rubberized snow removal attachment that is attached to the snow removal equipment using a quick release plate and a rubberized silage moving attachment that is attached to the silage moving equipment with the quick release plate.

The snow removal equipment typically used in combination with the snow removal and silage moving attachment device in the method 100 is a skid loader (not shown), although other pieces of snow removing equipment that are well known in the art can also be used. The silage moving equipment typically used in combination with the snow removal and silage moving attachment device in the method 100 is a tractor or a fork lift (not shown), although other pieces of silage moving equipment that are well known in the art can also be used.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

What is claimed is:

1. A snow removal attachment device used in combination with a piece of snow removal equipment, comprising:
a rubberized pushing tool that is disposed in front of said snow removal attachment device that pushes and moves snow while being used in combination with said snow removal equipment;
a mounting and quick release support bracket that removably mounts and secures said rubberized pushing tool to said snow removal equipment;
a plurality of fasteners and a quick release plate attaches said mounting and support bracket to said snow removal equipment; and
a stabilizing chain that stabilizes said rubberized pushing tool and said mounting and support bracket.

2. The device according to claim 1, wherein said rubberized pushing tool is made from a recycled tire section.

3. The device according to claim 2, wherein said recycled tire section is semi-circular shaped.

4. The device according to claim 1, wherein said fasteners are mounting bolts.

5. The device according to claim 1, wherein said snow removal equipment is a skid loader.

6. A silage moving attachment device used in combination with a piece of silage moving equipment, comprising:
a rubberized pushing tool that is disposed in front of said silage moving attachment device that moves silage while being used in combination with said silage moving equipment;
a quick release mounting and support bracket that removably mounts and secures said rubberized pushing tool to said silage moving equipment;
a plurality of fasteners and a quick release plate attaches said mounting and support bracket to said silage moving equipment; and
a stabilizing chain that stabilizes said rubberized pushing tool and said mounting and support bracket.

7. The device according to claim 6, wherein said rubberized pushing tool is made from a recycled tire section.

8. The device according to claim 7, wherein said recycled tire section is semi-circular shaped.

9. The device according to claim 6, wherein said fasteners are mounting bolts.

10. The device according to claim 6, wherein said silage moving equipment is a tractor.

11. The device according to claim 6, wherein said silage moving equipment is a fork lift.

12. A method for using a rubberized snow removal and silage moving attachment device or rubberized silage moving attachment used in combination with a snow removal equipment or silage moving equipment, comprising the steps of:
obtaining said rubberized snow removal or rubberized silage moving attachment;
attaching and mounting said rubberized snow removal or rubberized silage moving attachment to said snow removal equipment or said silage moving equipment; and
removing snow or moving silage with said rubberized snow removal or rubberized silage moving attachment and said snow removal equipment or said silage moving equipment as desired by a user.

13. The method according to claim 12, wherein said rubberized snow removal and silage moving attachment device or rubberized silage moving attachment device utilizes a pushing tool that is made from a recycled tire section.

14. The method according to claim 13, wherein said recycled tire section is semi-circular shaped.

15. The method according to claim 12, wherein said rubberized snow removal attachment is attached to said snow removal equipment with a quick release mounting and support bracket and a quick release plate.

16. The method according to claim 15, wherein said rubberized silage moving attachment is attached to said silage moving equipment with said quick release mounting and support bracket and said quick release plate.

17. The method according to claim 15 or 16, wherein said quick release plate is attached to said quick release mounting and support bracket with a plurality of fasteners.

18. The method according to claim 12, wherein said snow removal equipment is a skid loader.

19. The method according to claim 12, wherein said silage moving attachment is a tractor.

20. The method according to claim 12, wherein said silage moving attachment is a fork lift.
